(19) United States
(12) Patent Application Publication
(10) Pub. No.: US 2004/0049868 A1
(43) Pub. Date: Mar. 18, 2004

(54) Electric toothbrush with 3-dimensional brush head movements

(76) Inventor: Wai Fun Ng, New Territories (HK)

Correspondence Address: James A. LaBarre, BURNS, DOANE, SWECKER & MATHIS, L.L.P., P.O. Box 1404, Alexandria, VA, 22313-1404, US

(21) Appl. No.: 10/242,404

(22) Filed: Sep. 13, 2002

(51) Int. Cl. A61C 17/34

(52) U.S. Cl. 15/22.2; 15/22.1

(57) ABSTRACT

An electrical toothbrush having a longitudinally reciprocating brush head which automatically rotates about the longitudinal axis while undergoing longitudinal brushing movements in order to align the brush head with the curvature of the gum for better dental care. An example of a drive mechanism together with appropriate motion transformation means to gradually turn the plane of the brush head about the longitudinal axis during a reciprocating longitudinal teeth brushing motion is described.

### FIELD OF THE INVENTION

The present invention relates to electric toothbrushes and, more particularly, to electric toothbrushes having a brush head which is reciprocally movable along a longitudinal axis as well as about the same longitudinal axis.

### BACKGROUND OF THE INVENTION

Electric toothbrushes are well known and have been very popular because of the superior teeth and gum cleaning compared to cleaning by conventional manual toothbrushes.

Electric toothbrushes generally include a main housing with a handle portion inside which a motor is mounted. A brush head with bristles is usually connected to the motor shaft in order to generate the appropriate vibrations or other reciprocating motions. A transmission link is generally provided between the motor and the brush head to convert the uni-directional rotation of the motor shaft to the appropriate reciprocating teeth brushing motions. Examples of such appropriate teeth brushing motions include reciprocating motion along a longitudinal axis which is generally parallel to the axis of the motor shaft. Another type of such appropriate motions is by rotating the bristle holder about an axis which is generally perpendicular to the motor shaft axis or perpendicular to the plane of the brush head. U.S. Pat. No. 5,383,242 to Bigler Michael discloses a toothbrush having a reciprocating motion which combines a longitudinal reciprocating motion along a longitudinal axis which is parallel to the motor shaft as well as a rotational motion perpendicular to that longitudinal axis. Another type of brushing action is generated by the vibration of the brush head as a result of the vibrational movement of an eccentric weight attached to the motor shaft or gears attached to the motor shaft. In this latter design, the eccentric weight is usually located proximal to the motor in the housing and the vibrations generated is unpleasant for the user. Therefore, this eccentric weight generated vibration is less preferable in modern day electric toothbrush designs.

Dentist research reports have suggested that it is preferable to brush the teeth by following the veins of the teeth with the bristles of the toothbrush engaging the teeth along a direction which is generally normal to the plane of the teeth. While conventional electric toothbrushes provide a variety of reciprocating motions to enhance teeth brushing, there has been no specific and effective design of toothbrushes having a longitudinally reciprocating brush head which simultaneously provides automatic alignment of the brush head inclination so that the plane of the brush head can follow the general curvature of the teeth arrangements for optimal brushing.

### OBJECT OF THE INVENTION

It is therefore an object of the present invention to provide electric toothbrushes having a toothbrush head which is reciprocally movable along a longitudinal axis and, at the same time, providing automatic alignment of the brush head plane about the longitudinal axis in order to follow the curvature of the teeth arrangement for optimal tooth brushing. It is also an object of the present invention to provide specific embodiments of such a design of toothbrushes which are simple enough for practical utilization. At a minimum, it is an object of the present invention to provide an electric toothbrush with an improved brushing mechanism and/or brushing mode.

### SUMMARY OF THE INVENTION

According to the present invention, there is provided an electric toothbrush including an electric toothbrush including a brush head with bristles, an elongated main housing, a motion transmission link, motion generating means and motion transformation means, wherein:

said brush head includes an elongated stem for connecting said brush head to said motion generating means via said motion transmission link,

said motion generating means include means for generating reciprocating motions along a longitudinal axis,

said motion transmission link transmits the reciprocating motions generated by said motion generating means along said longitudinal axis to said elongated stem of said brush head,

said elongated stem is rotatable about said longitudinal axis while undergoing said reciprocating motions said longitudinal axis, and

said motion transformation means include means to rotate said brush head about said longitudinal axis while said elongated stem is undergoing reciprocating longitudinal motions along said longitudinal axis.

Preferably, the combination of said tracking means and said guiding means results in oscillatory movements of said bristle holder about said longitudinal axis as and when said elongated stem reciprocally moves along said longitudinal axis.

Preferably, further including a collar member which is provided with guiding means, said collar being received within said main housing and including a peripheral wall which generally extends along said longitudinal axis and surrounds at least a portion of said elongated stem of said bristle holder, said guiding means include at least a guiding track which is formed on said peripheral wall, said guiding track generally extends along said longitudinal axis longitudinally as well as transversally, said elongated stem of said bristle being provided with tracking means which follow the shape of said guiding track in response to the reciprocating longitudinal motion generated by said motion generating means, said transversal extension of said guiding track causes turning of said bristle holder about said longitudinal axis.

Preferably, said turning of said bristle holder about said longitudinal axis is reversed when said axial longitudinal motion of said elongated stem reverses.

Preferably, a spring member interconnects said collar member and said motion generating means, said spring member is disposed so that it is compressed by said motion generating means when said motion generating means moves said elongated stem along a first axial direction, said compressed spring member decompresses and moves said elongated stem along an axial direction opposite to that first axial direction when said motion generating means moves along that opposite axial direction.

Preferably, said spring member includes a helical spring disposed between said bristle holder and said motion generating means and surrounding at least a portion of said elongated stem.

Preferably, said motional generating means includes a motor having a motor shaft rotatable about a first axis parallel to said longitudinal axis, said rotational motion of said motor about said first axis being transformed into reciprocating motion along said longitudinal motion by gear arrangements, said gear arrangements include an eccentric crank arm arrangement, said eccentric crank arm arrangement transforms said rotational motion of said motor shaft into reciprocating motion of said crank arm along said longitudinal axis.

### BRIEF DESCRIPTION OF THE DRAWINGS

Preferred embodiments of the present invention of an electric toothbrush will be described in further detail below by way of example and with reference to the accompanying drawings, in which:

FIG. 1 is an exploded view of a first preferred embodiment of the toothbrush showing the major components,

FIG. 2 is a perspective view of the toothbrush of FIG. 1 assembled but with the main housing 22 removed to expose the moving parts,

FIG. 3 is a cross-sectional view taken longitudinally along the base of the bristle holder 11 of the toothbrush of FIG. 1 and viewed perpendicularly from the plane of the bristle holder towards the direction of extension of the bristles.

FIG. 4 is a longitudinal cross-sectional view of the assembled toothbrush of FIG. 1 showing an enlarged view of the connection between the motion generating means and the bristle holder,

FIG. 5 is a longitudinal view of the toothbrush of the present invention with the main housing removed and the tracking means disposed near the middle portion of the guiding track. The plane of the bristle holder 11 in this Figure has been turned by 90 degrees for convenient description,

FIG. 6 is a longitudinal view of the toothbrush of FIG. 5 with the tracking means located near the bottom and of the guiding track, and

FIG. 7 is a longitudinal view of the toothbrush of FIG. 5 with the tracking means located at the top and of the guiding track.

### DETAILED DESCRIPTION OF THE PREFERRED EMBODIMENTS

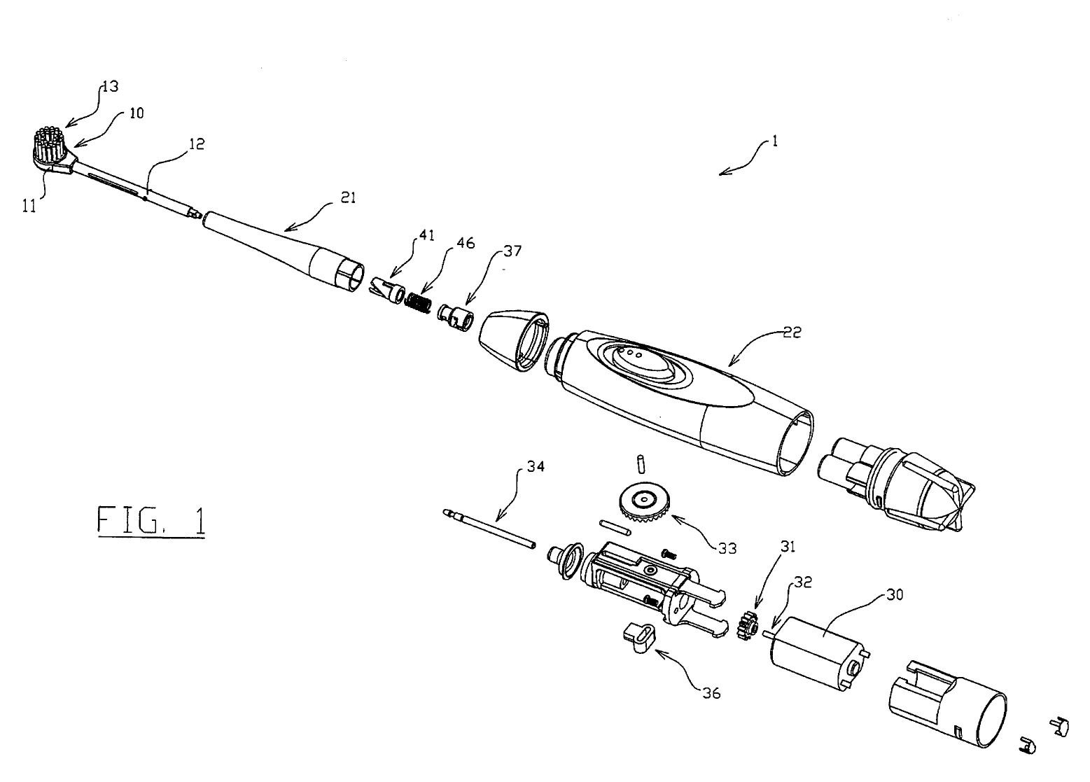

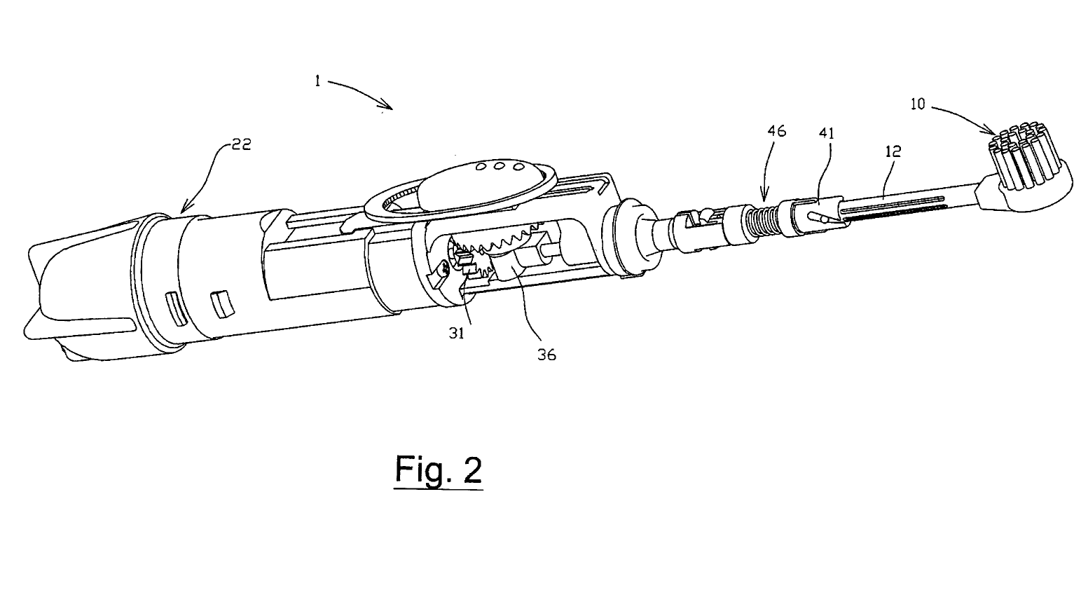

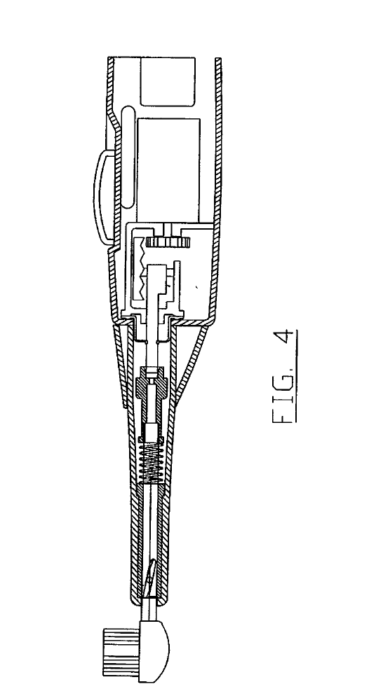

Referring to FIGS. 1-7 showing a first preferred embodiment of the present invention, the electric toothbrush 1 includes a brush head 10, a main housing 20 including a neck portion 21 and a handle portion 22, reciprocating motion generating means and motion transforming means. The main housing is preferably made of hard plastics and the handle portion 22 generally includes compartments for accommodating batteries and the motion generating means.

The brush head 10 includes a bristle holder 11 and an elongated stem 12 extending longitudinally from the lower side of the bristle holder towards the longitudinal end of the main housing 20. The bristle holder 11 includes a base surface from which bristles 13 extend generally in a perpendicular manner.

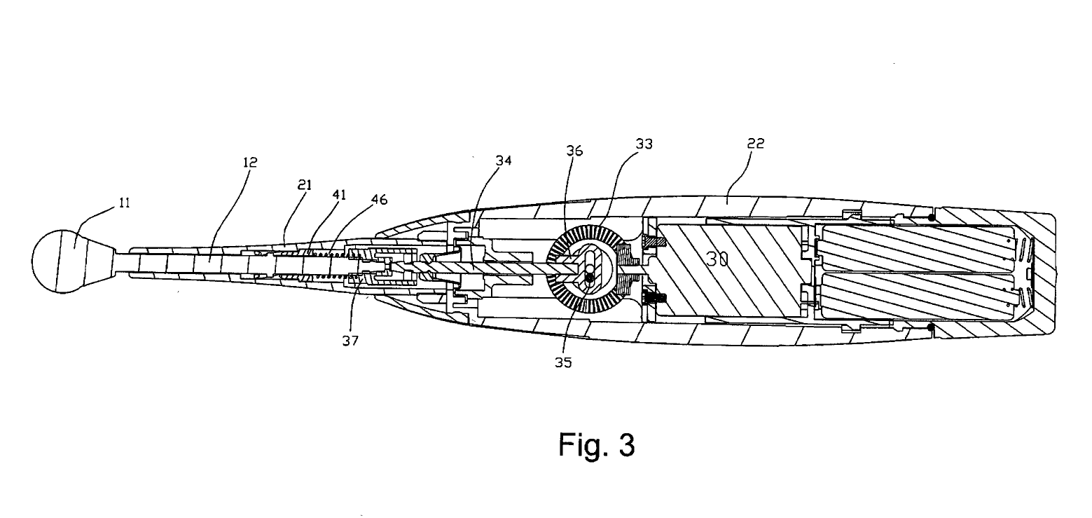

The reciprocating motion generating means include a motor 30 and a motion transmission link. The motor 30 is received within the handle portion 22 of the housing with the motor shaft 32 aligned generally parallel to the longitudinal axis of the elongated main housing 20 of the toothbrush 1. The motion transmission link includes a teethed wheel 31 mounted at the upper-most end of the motor shaft 32 with its plane of rotation generally perpendicular to the motor shaft 32. The teethed wheel 31 meshes with a crown or face gear 33 which is mounted on an axis which is generally perpendicular to the motor shaft 32 so that the main plane of the face gear 33 is generally parallel to the motor shaft 32. A crank arm 34 which is slidably movable along and within the neck portion 21 of the main housing 20 in a closely fitted manner is connected eccentrically to the face gear 33 via an off-centred pivotal driving pin 35 on the main plane of face gear 33. More precisely, the lower end of the crank arm 34 is connected to the off-centred pivotal driving pin 35 via a connecting piece 36, as is more particularly shown in FIG. 3.

The connecting piece 36 is a generally T-shaped member with a generally transversal slot along its wider portion for receiving the off-centred connecting pivotal driving pin 35. This transversal slot allows movement of the connecting pin 35 along the slot while the connecting pin 35 is undergoing circular motion due to the rotation of the face gear 33. Hence, the driving arrangement between the pivotal connecting pin 35 on the face gear 33 and the generally transversal slot on the connecting piece 36 facilitates the conversion of a rotational motion of the pivotal connecting pin 35 into a longitudinal reciprocating motion, since the crank arm 34 is restricted to be movable along the longitudinal axis. In other words, the rotational motion of the eccentric pivotal connecting pin 35 when driving the connecting piece 36 having the transversally extending slot will result in a reciprocating motion of the crank arm 34 along the longitudinal axis of the main housing 20 which is generally parallel to the axis of the motor shaft 32 in the present embodiment for driving the brush head 10.

The longitudinal movement of the crank arm 34 can of course be aligned with a different longitudinal axis by adjusting the inclination of the neck portion 21 with respect to the motor shaft 32 and with appropriate gear arrangements. Thus, with the combination of the motor 30 and the transmission link, and with the movement of the connecting crank arm 34 being restricted along the longitudinal axis of the main housing 20, rotational motions of the motor 30 about the axis of the motor shaft 32 will be transformed into longitudinal reciprocating motions of the crank arm 34 generally along the longitudinal axis of the housing 20 of the toothbrush 1.

In the present embodiment, the reciprocating motion generating means including the motor 30, the teethed wheel 31, the face gear 33, the crank arm 34, the pivotal driving pin 35, and the connecting piece 36 are formed as a subassembly inside the handle portion 22.

Referring to FIGS. 3 to 7, it will be noted that the elongated stem 12 of the toothbrush 1 is received inside the tubular housing of the neck portion 21 of the main housing 22 for connection to the crank arm 34. In the present embodiment, the crank arm 34 is connected to the elongated stem 12 via a connection member 37. More specifically, the connection member 37 includes a first collar portion for engaging with one end, the near end, of the crank arm 34 and a second collar portion for engaging with the distal end (i.e., the end not connected to the bristle holder 11) of the elongated stem 12. The first and second collar portions are generally co-axial hollow cylindrical members extending in the opposite directions along the longitudinal axis of the main housing 22, which is parallel to the motor shaft 32. Engagement means are formed on the second collar portion so that the elongated stem 12 is “locked-in” with the second collar portion. The engagement means in the present embodiment are a pair of apertures dimensionally corresponding to that of a pair of radial stud engaging members formed near the distal end of the elongated stem 12. Naturally, the hollow part of the second collar portion is dimensioned to receive that portion of the elongated stem 12 bearing the stud engaging members.

The near end of the crank arm 34 is connected to the first collar portion of the connection member 37 by corresponding fastening means. In this example, the near end of the crank arm 34 is shaped so that it has a head portion and a narrowed neck portion. The connection is done by trapping the head portion of the coupling end of the crank member 34 within the hollow body of the first collar portion of the connection member 37 by a radially and inwardly extending circumferential flange.

With this arrangement, it will be noted that the sub-assembly comprising the elongated stem 12, the connection member 37 and the crank arm 34 has a substantially constant length. In addition, the elongated stem 12 is rotatable relative to the crank arm 34 and the main housing 22 or the motor. Thus, it will be observed from the above arrangements that when the crank arm 34 advances towards the brush head 10, it will push the connection member 37 and therefore the elongated stem 12 to advance in the direction of the brush head 10. When the crank arm 34 retreats towards the motor end, the elongated stem will be withdrawn by the crank arm 34. It will also be noted that the elongated stem 12 can be rotatable about its longitudinal axis during such reciprocating motions.

In order to generate a combined longitudinal reciprocating motion along the axial direction as well as a reciprocating rotational motion of the brush head 10 about the longitudinal axis of its elongated stem 12 so that the plane of the brush head can be turned automatically to follow the curvature of the gum while performing the longitudinal reciprocating motions, a motion transforming means is provided between the brush head 11 and the motion generating means. The motion transformation means in the present embodiment includes a generally hollow collar member 41 which is received within the neck portion 21 of the main housing 20 at a location intermediate between the brush head and the connection member 37.

Referring to the Figures, it will be noted that the collar member 41 includes a hollow cylindrical body having a peripheral wall extending generally in the longitudinal or axial direction. A pair of longitudinally extending radial flanges are provided on the collar member 41 to prevent rotation of the collar member 41 inside the neck portion.

The elongated stem 12 of the brush head 10 is slidably received within the hollow portion of the collar member 41 so that the collar member 41 surrounds different portions of the elongated stem 12 during the longitudinal motions of the elongated stem 12. In general, the collar member 41 is disposed intermediate between the distal end of the elongated stem and the lower side of the brush head 10. In order to provide a gradual and automatic alignment or turning of the plane of the bristle holder 11 about the longitudinal axis of the elongated stem 12 while the elongated stem 12 is undergoing reciprocating motions along the longitudinal axis, guiding means are formed on the collar member 41. In the present specific embodiment, the guiding means include at least a guiding track 45 which extends along the longitudinal direction as well as transversally so that the resulting guiding track 45 is non-parallel to the longitudinal axis of the motor shaft 32 or the axis of the main housing 20.

Tracking means are provided on the elongated stem 12 so that the elongated stem 12 can follow the shape of the guiding path formed by the guiding means to cause turning of the brush head 10 about the longitudinal axis. The tracking means in the present specific embodiment includes a pair of studs extending radially from the elongated stem 12. The studs are preferably closely fitted within the guiding tracks 45 to permit close and accurate tracking of the gradual longitudinal and transversal variation of the path during longitudinal movements. A helical spring 46 is disposed on the elongated stem 12 between the lower end of the collar member 41 and the upper end of the connection member 37. The compression in this spring 46 helps to maintain the longitudinal disposition of the collar member 41 relative to the neck portion 21. Also it may provide additional assistance for the elongated stem 12 to return towards the handle portion when the crank arm 34 retreats towards the motor end.

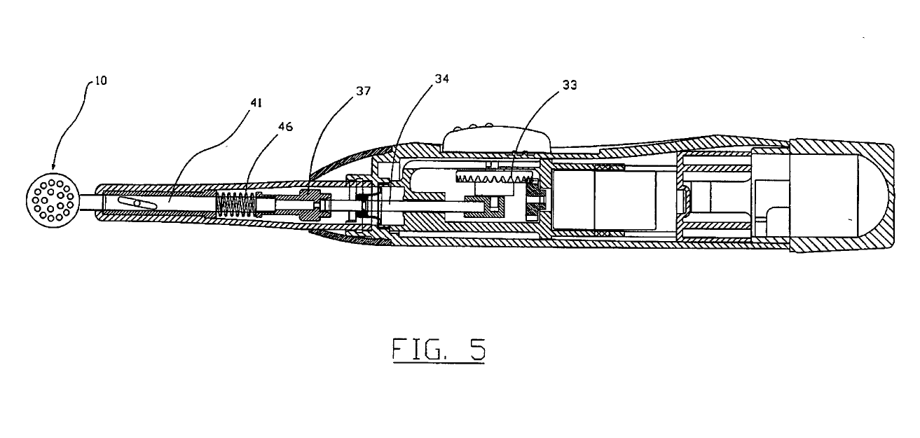

The operation of the toothbrush of the present invention will be further explained by reference to FIGS. 5-7 below. In these drawings, the plane of the brush head 10 relative to the elongated arm 12 has been twisted by 90° for convenient explanation by reference to the moving parts as shown in the Figures. In the following description, reference to the front section of the housing 22 means the part of the housing that has been removed to expose the moving parts. The phrases “left” and “right” sides of the handle refer to the respective sides of the handle when viewing from the front portion of the housing and out of the drawing page.

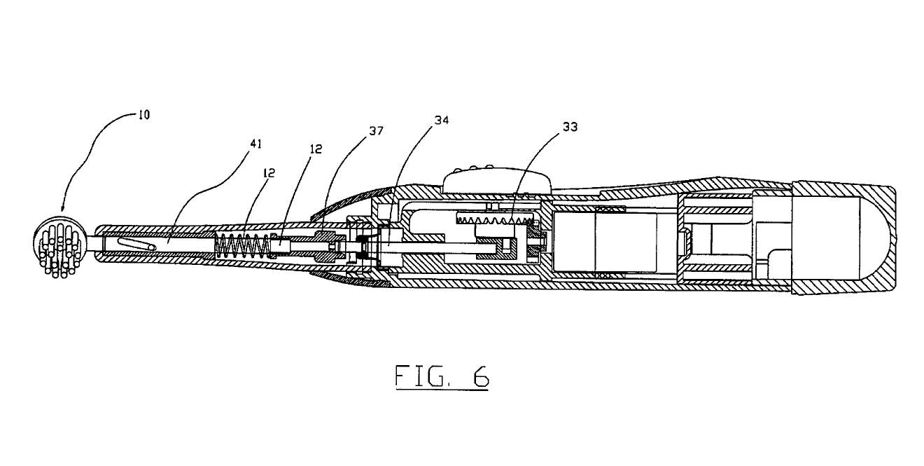

Referring to FIG. 5, it will be noted that the tracking means formed on the elongated stem is disposed at about the middle portion of the guiding track 45 formed on the collar member. This corresponds to a position at which the bristles are generally perpendicular to the front portion of the main housing. When the motor shaft 32 rotates so that the crank arm 34 is moved downwards towards the motor, as shown in FIG. 6, the tracking means formed on the elongated stem 12 will be moved downwards towards the lower end of the guiding track 45. When this movement is complete, the skewness or the transversal component of the tracking slot has caused the plane of the brush head 10 to move towards the right side of the handle.

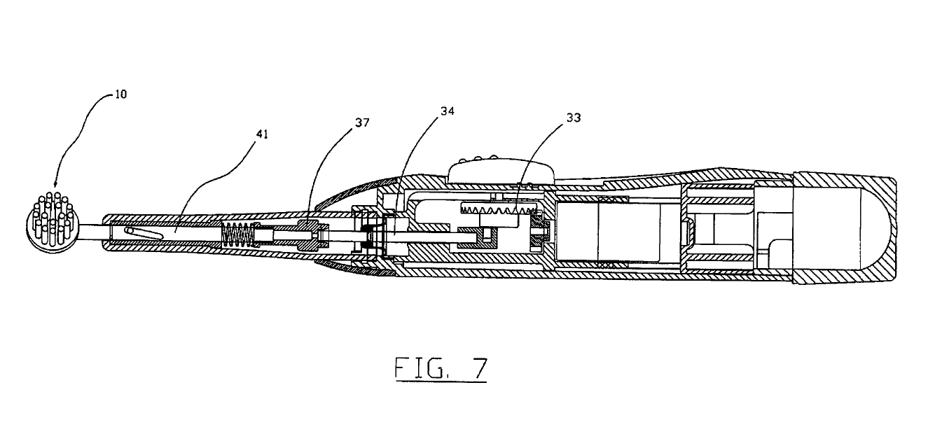

When the motor shaft 32 continues to rotate, the crank arm 34 will reverse direction and push the elongated stem 12 to move upwards. At the same time, the angular direction of rotation of the brush head reverses and the brush head 10 will be restored to the previous position of FIG. 5 when the tracking means returns to the middle portion of the tracking slot. At this instant, the plane of the brush head 10 is substantially parallel to the front portion of the main housing 22. Further rotation of the motor shaft will drive the elongated stem 12 further upwards and, at the same time, the co-operative movement between the tracking means along the guiding tracks 45 will result in simultaneous and gradual rotation of the plane of the bristle holder towards the left side of the front portion of main housing 22, as shown in FIG. 7.

Of course, the plane of the brush head can be aligned in a different manner so that the correlation between the angle of the plane of the brush head and the main housing can be varied or even reversed. Thus, by utilizing a collar member having tracking means disposed between the brush head and the connection member, a purely longitudinal reciprocating motion can be transformed into a combined longitudinal and rotational motion respectively along and about the axis to enhance performance of the toothbrush by providing automatic alignment of the plane of the bristle so that the plane of the bristles can be substantially perpendicular to the plane of the teeth to be brushed. It will be noted that when the connection member is moved upwards, the helical spring will be compressed.

When the connection member is moved upwards to the bristle holder as a result of further rotational movement of the motor shaft, the stored compression of the compressed spring 46 will help to return the elongated stem downwards to prepare for the next upward movement.

In the present specific embodiment, the tracking slot is generally inclined to the longitudinal axis at a substantially constant inclination. It will of course be appreciated that the slot or guiding tracks can be made into different curvatures, for example, concavely or convexly, to suit the appropriate turning rate of the plane of the bristle head. It will be appreciated that although the guiding means of the present specific embodiment define a path which gradually diverges from the longitudinal axis of the elongated stem 12 as the path extends towards the bristle holder, the guiding means can be designed to form a convergent path towards the brush head instead.

While the present invention has been explained by reference to the preferred embodiments described above, it will be appreciated that the embodiments are only examples provided to illustrate the present invention and are not meant to be restrictive on the scope and spirit of the present invention. The scope of this invention should be determined from the general principles and spirit of the invention as described above. In particular, variations or modifications which are obvious or trivial to persons skilled in the art, as well as improvements made on the basis of the present invention, should be considered as falling within the scope and boundary of the present invention. Furthermore, although the present invention has been explained by reference to a specific embodiment of utilizing a collar member formed with guiding tracks for motion transformation, it should be appreciated that the invention can apply, whether with or without modification, to other forms of electric toothbrushes with different forms of motion transformation means to achieve the desirable combined longitudinal and rotational motion along and about the same longitudinal axis without loss of generality.

1. An electric toothbrush including a brush head with bristles, an elongated main housing, a motion transmission link, motion generating means and motion transformation means, wherein:
said brush head includes an elongated stem for connecting said brush head to said motion generating means via said motion transmission link,
said motion generating means include means for generating reciprocating motions along a longitudinal axis,
said motion transmission link transmits the reciprocating motions generated by said motion generating means along said longitudinal axis to said elongated stem of said brush head,
said elongated stem is rotatable about said longitudinal axis while undergoing said reciprocating motions said longitudinal axis, and
said motion transformation means include means to rotate said brush head about said longitudinal axis while said elongated stem is undergoing reciprocating longitudinal motions along said longitudinal axis.

2. A toothbrush according to claim 1, wherein said motion transformation means include guiding means and tracking means, said guiding means guide said tracking means to rotate about said longitudinal axis while said tracking means move along said longitudinal axis.

3. A toothbrush according to claim 2, wherein said motion transformation means include a generally cylindrical collar member surrounding said elongated stem, said guiding means include a guiding track on the cylindrical surface of said collar member, said guiding track extends between the longitudinal ends of said collar member and is non parallel to said longitudinal axis, said tracking means include a tracking member which is slidably movable along said guiding track.

4. A toothbrush according to claim 3, wherein said tracking means include stud means extending radially from said elongated stem.

5. A toothbrush according to claim 1, wherein the direction of rotation of said brush head about said longitudinal axis reverses when direction of the longitudinal motion of said elongated stem reverses.

6. A toothbrush according to claim 1, wherein said motion transmission link includes a crank arm and a connection member, said connection member connects said elongated member to said crank arm, said crank arm includes a head portion disposed adjacent to a narrowed neck portion for coupling to said connection member, said connection member includes a hollow cylindrical body with an inwardly extending radial flange, said head portion of said crank member being retained within said hollow cylindrical body of said connection member by said inwardly extending radial flange.

7. A toothbrush according to claim 6, wherein said crank arm and said connection member are rotatable relative to each other about said longitudinal axis.

8. A toothbrush according to claim 6, wherein said motion transformation means include a generally cylindrical collar member surrounding said elongated stem, said guiding means include a guiding track on the cylindrical surface of said collar member, said guiding track extends between the longitudinal ends of said collar member and is non parallel to said longitudinal axis, said tracking means include a tracking member which is slidably movable along said guiding track, a spring member is disposed between the cylindrical collar member of said motion transformation means and the connection member of said motion transmission link, said spring member is disposed so that it is compressed by said connection member of said motion transmission link when said connection member moves towards said collar member, said spring member pushes said elongated stem away from said collar member when connection member moves away from said collar member.

9. A toothbrush according to claim 8, wherein said spring member includes a helical spring surrounding at least a portion of said elongated stem.

10. A toothbrush according to claim 1, wherein said longitudinal axis is generally parallel to the longitudinal axis of said elongated main housing.

11. A toothbrush according to claim 1, wherein the angular direction of rotation of said brush head about said longitudinal axis is reversed when the direction of said axial longitudinal motion of said elongated stem reverses.

12. A toothbrush according to claim 1, wherein said motional generating means includes a motor having a motor shaft rotatable about a first axis parallel to said longitudinal axis, said rotational motion of said motor about said first axis being transformed into reciprocating motion along said longitudinal motion by gear arrangements, said gear arrangements include an eccentric crank arm arrangement, said eccentric crank arm arrangement transforms said rotational motion of said motor shaft into reciprocating motion of said crank arm along said longitudinal axis.
